(19) United States
(12) Patent Application Publication
(10) Pub. No.: US 2025/0030713 A1
(43) Pub. Date: Jan. 23, 2025

(54) STEMS AND METHODS FOR SECURING A SERVICE BY DETECTING CLIENT-SIDE WEB PAGE TAMPERING

(71) Applicant: BEHAVIOSEC INC., SAN FRANCISCO, CA (US)

(72) Inventors: Raphaël Karampournis, Råneå (SE); Mattias Wallbing, Luleå (SE); Per Burström, Luleå (SE); Julia Fischer, Luleå (SE)

(21) Appl. No.: 18/355,478

(22) Filed: Jul. 20, 2023

(51) Int. Cl. H04L 9/40

(52) U.S. Cl. CPC H04L 63/1425; H04L 63/1466

(57) ABSTRACT

System and methods are provided for client-side web page tampering assessment and fraud prevention by detection of one or more events that are uncharacteristic of user-specific behavior. A method is provided for monitoring a web page Document associated with a Document Object Model (DOM) of a browsing session of a user, capturing one or more event-based mutations of the web page Document, and retrieving, from a profile repository, user behaviometric history data. Responsive to comparing the one or more event-based mutations to the user behaviometric history data, the method can include denying continuation of the browsing session based on a predetermined similarity mismatch of the one or more event-based mutations to entries in the user behaviometric history data and output one or more indications of potential fraud.

### FIELD OF THE DISCLOSED TECHNOLOGY

The disclosed technology generally relates to internet browsing security, and more particularly to systems and methods for detecting and preventing fraudulent client-side web modifications that are uncharacteristic of a particular user.

### BACKGROUND

Web page tampering is strongly associated with fraudulent behavior, especially when client-side modifications to a web page are made via developer tools and/or via remote-access. A fraudster, for example, can cause visible content on user's web browser to differ from the intended code/content provided by a web server. Such tampering can allow a scammer to easily cause a user to unknowingly perform unintended actions.

An example of web page tampering can involve social engineering fraud by a scammer who could pose as a “technical support worker” to convince a user to let the scammer remotely access the user's computing device. Once access is provided, the scammer may use script injection or other custom code to fill-out an online transaction form to stealthily change the values in the fields/code in a way that it doesn't change what is displayed to the user. Such tampering can include multiplying monetary values, registering another monetary transaction beneficiary in the form fields, redirecting a transaction, etc. Such value changes can happen in under a millisecond and can be invisible to the end-user.

Script injection currently can be detected by comparing scripts used in a Document interface against a set of allowed scripts. However, using this method to check against allowed scripts requires pre-configuration, and may not detect ephemeral scripts that can be added to the Document, but are removed before the document is being replaced, for instance, when the user navigates to another page. Usually, such scripts are added and removed from the Document as soon as the code is executed. In some instances, the resulting code can persist in the process even after the script is removed, which can be highly correlated with fraudulent intent.

Injected script detection using traditional methods does not reliably work because such methods run only at specific points in the user journey through a web page, or at set intervals. The use of traditional methods to detect script injection at the millisecond timeframe can severely deteriorate the user interface and user's experience. Furthermore, scripts that are appended to a Document can be run and removed in under less than a millisecond. Such scripts still can affect the JavaScript process of the page even after deletion.

Traditional solutions to detect client-side web page via detection of associated web page Document changes typically use only information that is being sent back to the server, and not what is being displayed to the user on the client-side. Furthermore, current extension profiling may only look for specific code variables that are being injected into the Document. However, such variables can be renamed, removed, or new variables can be added as extensions evolve with time. Although very precise, keeping track of the code variables may require substantial efforts to stay up-to-date and avoid false positives and false negatives. Thus, the conventional solutions do not provide tangible information on what function the end-user's extensions perform, and no pattern can clearly be created from such information that would not trigger a false-positive when an end-user replaced one of their extensions with another one with the same purpose, which is a common behavior. For example, extensions being deprecated can force the users to get a replacement extension. Therefore, extension profiling using existing technologies is also not reliable.

There is a need for improved systems and methods for detecting client-side web page tampering.

### BRIEF SUMMARY

Certain exemplary implementations of the disclosed technology may include a method for client-side web page tampering assessment and fraud prevention by detection of one or more events that are uncharacteristic of user-specific behavior.

In accordance with certain implementations of the disclosed technology, a method is provided for monitoring, with a MutationObserver instance, a web page Document associated with a Document Object Model (DOM) of a browsing session of a user, capturing one or more event-based mutations of the web page Document, and retrieving, from a profile repository, user behaviometric history data. Responsive to comparing the one or more event-based mutations to the user behaviometric history data, the method can include denying continuation of the browsing session based on a predetermined similarity mismatch of the one or more event-based mutations to entries in the user behaviometric history data and output one or more indications of potential fraud. Certain implementations may include authorizing continuation of the browsing session based on a predetermined similarity match of the one or more event-based mutations to entries in the user behaviometric history data.

In accordance with certain implementations of the disclosed technology, a system is provided and configured to assess client-side web page tampering and prevent fraud by detection of one or more events that are uncharacteristic of user-specific behavior. The system includes a processor and a memory having programming instructions stored thereon, which, when executed by the processor, cause the processor to monitor, with a MutationObserver instance, a web page Document associated with a Document Object Model (DOM) of a browsing session of a user, detect one or more event-based mutations of the web page Document, store the one or more event-based mutations in the memory, retrieve, from a profile repository, user behaviometric history data, compare the one or more event-based mutations to the user behaviometric history data and deny continuation of the browsing session based on a predetermined similarity mismatch of the one or more event-based mutations to entries in the user behaviometric history data and output one or more indications of potential fraud. Certain implementations may include authorizing continuation of the browsing session based on a predetermined similarity match of the one or more event-based mutations to entries in the user behaviometric history data.

In accordance with certain implementations of the disclosed technology, a non-transitory computer-readable medium having stored thereon software instructions that, when executed by a processor, cause the processor to perform a method of monitoring, with a MutationObserver instance, a web page Document associated with a Document Object Model (DOM) of a browsing session of a user, capturing one or more event-based mutations of the web page Document, and retrieving, from a profile repository, user behaviometric history data. Responsive to comparing the one or more event-based mutations to the user behaviometric history data, the method can include denying continuation of the browsing session based on a predetermined similarity mismatch of the one or more event-based mutations to entries in the user behaviometric history data and output one or more indications of potential fraud. Certain implementations may include authorizing continuation of the browsing session based on a predetermined similarity match of the one or more event-based mutations to entries in the user behaviometric history data.

Certain implementations of the disclosed technology will now be described with the aid of the following drawings and the detailed description.

### BRIEF DESCRIPTION OF THE DRAWINGS

FIG. 1 is an example block diagram illustration of a system, according to certain implementations of the disclosed technology.

FIG. 2 is an example block diagram of a system, in accordance with certain exemplary implementations of the disclosed technology. in which a MutationObserver may monitor a DOM of a webpage for detection and prevention of fraudulent tampering.

FIG. 3 is an example flow-diagram for terminating a browsing session based on monitored DOM changes that are not consistent with user prior behavioral inputs, in accordance with certain exemplary implementations of the disclosed technology.

FIG. 4 is a high-level block diagram of a computing device that may be used to conduct embodiments of the disclosed technology.

FIG. 5 is a flow diagram of a method, in accordance with certain implementations of the disclosed technology.

The disclosed technology will now be described using the detailed description in conjunction with the drawings and the attached claims.

### DETAILED DESCRIPTION

The systems and methods disclosed herein can enable the detection of Document modifications on the client-side to identify web page tampering. Such tampering can used by fraudulent actors to deceive a victim user because it creates differences between a web page's visible content and the code. In some embodiments, the disclosed technology may be used to mitigate such attacks.

In accordance with certain exemplary implementations of the disclosed technology, a Document Object Model (DOM) tree of a web page may be monitored using a MutationObserver interface, for example, to receive notifications through its callback function when the DOM changes, as will be discussed in detail below.

Certain implementations of the disclosed technology may also utilize a profile of user-specific behavior(s) of usual browser document modifications (such as enabling extensions for dark mode, content translation, popup suppression, etc.,) so that specific normal user settings and web page interaction behavior can be assessed in relation to current browsing changes to mitigate false alarms.

Certain implementations of the disclosed technology may enable detection of script injection in the Document without requiring pre-configuration. Furthermore, ephemeral script injection may be detected using certain implementations of the disclosed technology.

The disclosed technology can be used for fraud mitigation by the detection of Document mutations (such as script injection or code-triggered field values changes), which may be evaluated for authorizing or denying an online session. In certain implementations, an event-based methodology may be utilized to detect changes made to the Document. An event, for example, can be an action or change in the Document, or may be associated with a JavaScript thread of a page that is triggered by a user interaction, or by the web page's code itself, developer tools, extensions, etc. In certain implementations, the Document or JavaScript thread may be monitored for such changes independent of their source of change.

In certain implementations, mutation events may be used to detect any changes made to the DOM tree. In certain implementations, silent changes that might only affect the JavaScript thread of a page may be monitored to catch all scripts injections.

In certain instances, transaction values displayed to the user may differ from the actual values in the underlying code. In certain implementations, the disclosed technology may enable detection of such silent alterations of a Document.

In certain implementations, advanced usage may be detected by matching patterns related to document mutations that are not accessible, for example, to regular users without advanced knowledge of browsers and code.

The disclosed technology can provide technical benefits for the practical application of online fraud detection and mitigation in several ways, including but not limited to: (1) providing s list of changes and a timeline of the changes made to a web page Document; (2) detecting remote access scenarios where a fraudster alters the appearance of web page that is presented to the end user; (3) avoiding false positives by profiling online behaviors of advanced users, for example, who regularly use plugins that alter a web page (e.g., plugins that force dark mode, add extra functionalities to the page, remove cookies, remove popups, clears paywalls, etc.); (4) detecting other odd behavior (e.g., the use of browser/plugins to translate pages); and/or (5) detecting script injection and addition and/or removal events (for ephemeral scripts) along with a complete and accurate timeline of the scripts. In certain implementations, the process of script injection detection can be controlled to run at predetermined intervals or at specific user journey events. Certain implementations of the disclosed technology may be utilized for detecting both hidden and visible change made to the DOM tree with an event-based approach. In certain implementations, changes made under the millisecond timeframe can be detected and mitigated.

Further details of the disclosed technology will now be explained with reference to the accompanying figures.

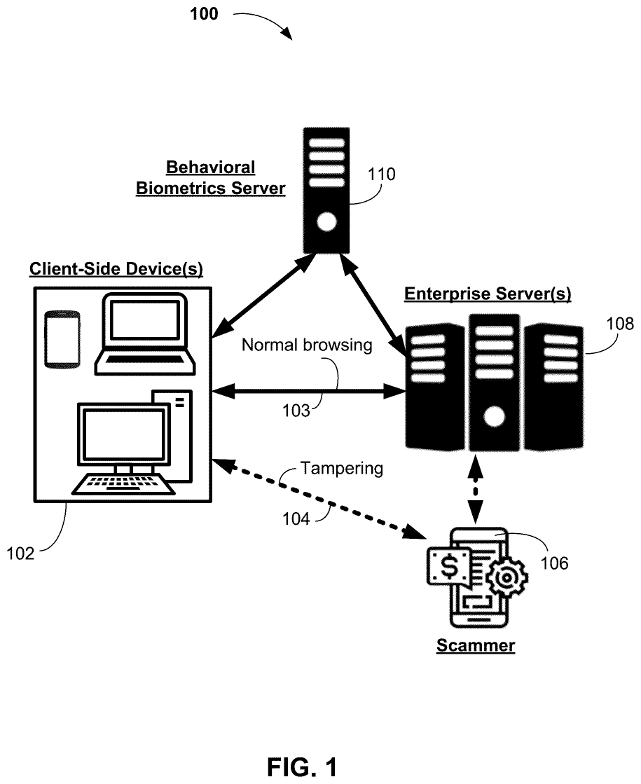

FIG. 1 is an example block diagram illustration of a system 100, according to certain implementations of the disclosed technology, which may be utilized to assess client-side web page tampering, which can be used to prevent associated fraud. In certain implementations, the system 100 can include client devices 102 (such as a desktop computer, laptop computer, tablet, mobile device, etc.) in communication with an enterprise server 108. During normal web page browsing 103, the enterprise server 108 may “serve” one or more web pages to the client device 102 for viewing and interaction by a user. However, in certain instances, a scammer 106 may (with or without the user's knowledge) tamper 104 with the client device 102 to cause portions of a served web page to appear different than intended by the enterprise server 108, for example, by remote access and/or via script injection.

As discussed above, there are instances where a legitimate user may utilize plugins (or other advanced user tools) to alter the appearance of their browsing session. To avoid or minimize instances where a legitimate user is flagged for potentially fraudulent activity related to their normal behavior, the system 100 may utilize a behavioral biometrics server 110 to build and use a user profile to catalog Document changes that are consistent with normal use of the specific user. In certain implementations, the system 100 may check the user profile against DOM tree change entries (as provided by the MutationObserver, for example) to distinguish between normal and potentially fraudulent activities. In this way, the disclosed technology can provide an enhanced user experience and protection while minimizing false positives.

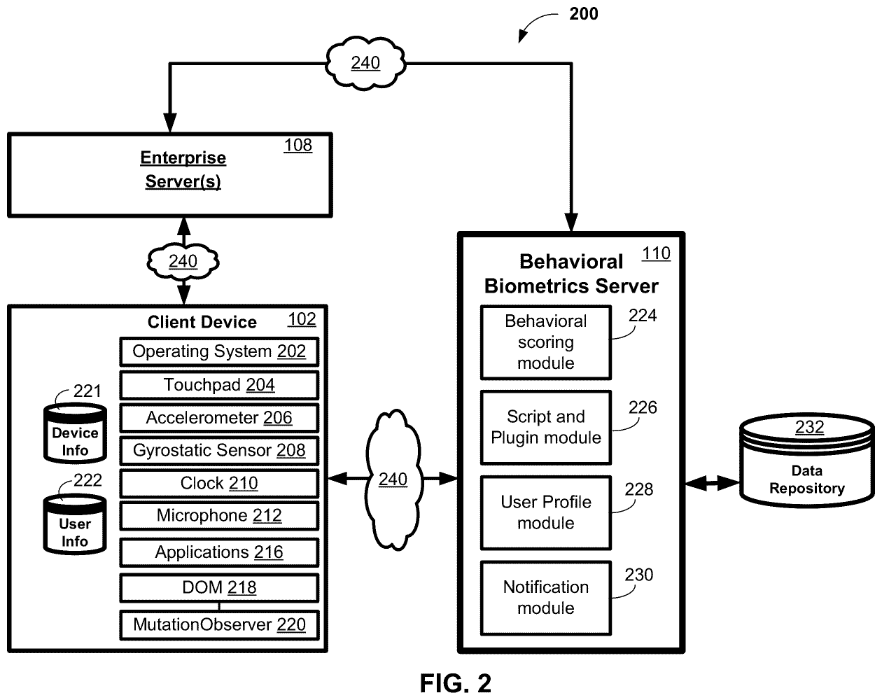

FIG. 2 is a more detailed example block diagram of a system 200, in which certain components such as the client device 102, the enterprise server 108 and/or the behavioral biometrics server 110 may be embodied like the system 100 as discussed in FIG. 1.

In certain exemplary implementations, the client device 102 may include an operating system 202, a clock 210, applications 216, and one or more of a touchpad 204, an accelerometer 206, a gyrostatic sensor 208, and/or a microphone 212. Certain device info 221 may be stored in the memory of the client device 102. In certain exemplary implementations, user info 222 may be stored in the memory of the user's client device 102. In accordance with certain exemplary implementations of the disclosed technology, the MutationObserver 220 may be utilized to distinguish changes in the DOM 218.

In certain exemplary implementations, the (user's) client device 102, the enterprise server 108, and/or the behavioral biometrics server 110 may be in communication with one another via communications channels 240 including, but not limited the Internet.

The behavioral biometrics server 110 may include various modules, such as a behavioral scoring module 224, a script and plugin module 226, a user profile module 228, a notification module 230, etc., which may be used to enable the various functions of the behavioral biometrics server 110.

Certain exemplary implementations of the behavioral biometrics server 110 may be in communication with a data repository 232, for example, which may be used to store user, device, and/or previous behavioral data, and which can be updated and retrieved for comparisons against current behavioral data. In certain implementations, the data repository 232 may retrieve device info 221 and/or user info 222 from the client device 102 via the behavioral biometrics server 110 to update the data repository 232. In certain implementations, the user profile module 228 may be used for retrieving, comparing, and updating user profile information stored in the data repository 232.

The behavioral scoring module 224, for example, may be utilized for determining whether the (user's) client device 102 is interacting with the enterprise server 108 under normal web page browsing modes that are typically/historically used on the client device 102, or if changes to the DOM 218 on the (user's) client device 102 (for example, as detected by the MutationObserver 220) stem from a process, plugin, script, etc., that differs from those previously used on the client device 102. In certain implementations, the user and/or device historical profile data can be stored in the user info 222, device info 221, and/or the data repository 232.

In certain implementations, the behavioral scoring module 224 can include a script and plugin module 226 that may work in conjunction with the behavioral scoring module 224 and/or the user profile module 228 to catalog known whitelisted and/or blacklisted scrips/plugins and/or known scammer device information to further speed up the process of distinguishing legitimate browsing modes from potentially fraudulent modes.

In accordance with certain exemplary implementations of the disclosed technology, the notification module 230 may be utilized to generate and send an alert or notification to the enterprise server 108, the client device 102, and/or an alternate communication channel (such as text or e-mail) to a user associated with the client device 102 when suspicious activity has been detected. In certain implementations, the alert or notification provided by notification module 230 may be configured to interrupt further communication between the client device 102 and the enterprise server 108 when changes to the DOM 218 are determined to be above a predetermined fraud threshold. Thus, in the system 200, the MutationObserver 220 may monitor the DOM 218 associated with a web page for detection of one or more events that are uncharacteristic of user-specific behavior, and the system 200 may be utilized for the prevention of fraudulent tampering.

In certain implementations, the MutationObserver 220 can be embodied as an interface that provides the ability to watch for all the changes being made to the DOM 218 tree. Any mutation done to the DOM 218 may cause an event that triggers the MutationObserver 220. This event can provide the MutationObserver 220 with information about what, when, and where the change occurred, along with the values before the changes. In certain implementations, the MutationObserver 220 can be instantiated with custom code to also enhance what information is being collected.

In certain implementations, a mutationsList variable may be declared to hold a list of all Document mutations. The MutationObserver 220, for example, may be instantiated in another variable called mObserver with a parameter or function called updateMutationsList that may update the mutationsList with all DOM mutations done to one or several elements of the page. Such mutations may trigger the MutationObserver 220 instance and add any other information that can be computed on the fly and/or used to identify the source of the mutation.

In certain implementations, an observe( ) method of mObserver may be called with some or all options enabled, which may register some or all mutations in the Document. In one example implementation the MutationObserver 220 and the observe( ) method may be used to observe mutations on visible elements in a page that are known to be used in scamming scenarios. For instance, in a scenario where a scammer impersonates a technical support worker and convinces a user to let them remotely take control of the user/client device with their agreement, the scammer may fill an online transaction form and may stealthily change values in the fields (and underlying code) in a way that doesn't change what is displayed to the user before the transaction is sent to the related server(s) or redirected to a different server. Such value changes can happen in under a millisecond, and thus may be invisible to the end-user. The systems and methods disclosed herein may be used to detect and prevent such changes.

In another example scenario, a scammer may alter a form's output so that it does not match what is visible to the user. Such alterations can include multiplying monetary values or registering another monetary transaction beneficiary to the form fields. The systems and methods disclosed herein may be used to detect and prevent such changes.

In another example scenario, the systems and methods disclosed herein may be utilized to detect injected scripts. Script injection in a Document will mutate the DOM by adding a <script> tag, which will trigger mObserver. This way, if a page is altered using a script to run a function that changes an input field's value (even for less than a millisecond), the change may automatically trigger mObserver, which may update the mutationsList with information about that particular Document mutation and list things such as the script's content, the old input field's value, the new value, the modified input field, and the time of the change. All of this information may be sent to behavioral biometrics server 110 for analysis and processing, which may result in an alert or notification from the notification module 230 to revoke access, as discussed above.

In another scenario involving injected script that is programmed to remove itself after running (if even for a millisecond), the MutationObserver 220 would still be able to catch the script and its content.

In another scenario, a malicious entity may run custom code on a victim's computer via a browser extension with vulnerabilities. In this scenario, the scammer may attempt to gather the victim's credentials by adding a custom script to the Document that listens for value changes in the login form fields on websites the user visits. After the script executes, it may remove itself without erasing the malicious logic from the JavaScript thread of the page. This script injection would also mutate the DOM 218 tree as soon as the script is added to the page, even before its content is being executed, and therefore, would be caught by mObserver. The full content of the injected script may be stored in the mutationsList, even after the malicious script erased itself. Such information may be transmitted to the script and plugin module 226 for analysis by the behavioral biometrics server 110.

In another example scenario, certain implementations of the disclosed technology may be used to identify and allow certain “advanced user” patterns normally employed by the user, such as the extensive use of browser extensions that may register as Document mutations the document by adding extra functionalities such as one-click login, new visual interfaces with shortcuts to specific pages, forced usage of dark mode, ad blockers, tracker-removal, cookie cleaners, etc. Since such extensions interact with the DOM 218 tree of a web page, all these mutations would be caught by mObserver and could be checked against the specific user data, for example, via the user profile module 228 and/or the script and plugin module 226 to determine whether such functionalities are considered normal for the specific user so that the browsing session is not interrupted due to a false positive.

Various implementations of the disclosed technology may be utilized to determine modes of online interactions that are consistent with historical behavioral biometrics data of a specific user. Certain implementations of the use of behavioral biometrics data is discussed in U.S. Pat. No. 10,068,076 entitled “Behavioral authentication system using a behavior server for authentication of multiple users based on their behavior,” which is incorporated by reference herein as if presented in full.

Since privacy modes, malware, and/or data aggregation may inhibit the use of behavioral data, situations can arise when behavioral biometrics algorithms may be unknowingly subjected to a browser's privacy mode, malware, or some type of aggregator. Certain implementations of the disclosed technology may detect online communication modes in which behavioral data may be impacted by privacy settings, malware, or an aggregator such that behavioral biometrics may not be relied upon to identify and/or track users.

Conventional behavioral biometrics systems do not have a way of handling mismatched or manipulated behavioral data (i.e., due to a bot, aggregator, malware, and/or browser privacy mode) and often, a legitimate user's session may be flagged with a false positive due to the changed behavioral-related timing distributions. In contrast, the disclosed technology may be utilized to detect changes to the DOM 218 and may allow the system to utilize behavioral biometrics and a user profile to handle such instances rather than incorrectly flagging the communications session as fraud/positive. Certain exemplary implementations of the disclosed technology may enable the suppression of false positives for behavioral biometrics via the detection of the changes to the DOM 218 in combination with a corresponding check against the user profile data.

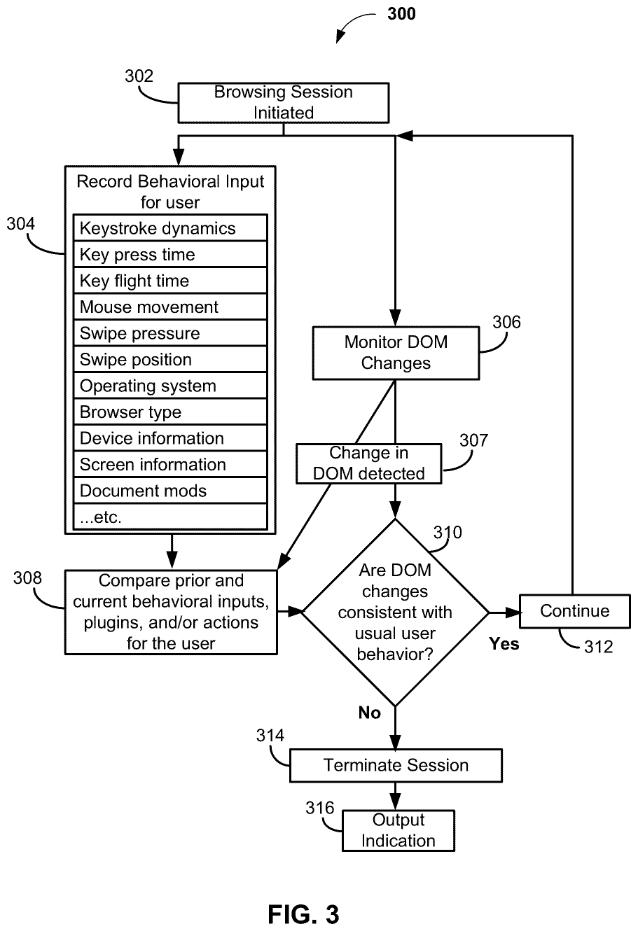

FIG. 3 is an example flow-diagram of a method 300 for terminating a browsing session based on monitored DOM changes that are not consistent with user prior behavioral inputs, in accordance with certain exemplary implementations of the disclosed technology. In block 302, a browsing session may be initiated, for example, between a client device 102 and an enterprise server 108. In block 304, various user behavioral input may be monitored and recorded, for example to establish a user profile and/or to supplement/update an existing user profile. Such monitored/recorded behavioral input can include keystroke dynamics, key press time, key flight time, mouse movement, swipe pressure, swipe position, operating system information, browser type information, plugin information, device information, screen information, Document modifications, etc. Such user behavioral information may be utilized to establish usual browsing settings and behaviors for a particular user, and such information may be stored in a user profile. In parallel with block 304, and as indicated in block 306, the method 300 may monitor DOM changes. Responsive to a detected change in the DOM, as indicated in block 307, the method 300 may trigger a comparison of the user's prior and current behavioral inputs, as indicated in block 308. In certain implementations, the detected changes in the DOM may trigger an evaluation, as indicated in decision block 310, to determine if the detected DOM changes are consistent with the usual user behavior. If the detected DOM changes are consistent with the usual user behavior, then the browsing session may continue as shown in block 312, and the DOM and user behavioral input may continue to be monitored. However, if the detected DOM changes are not consistent with the usual user behavior, the browsing session may be terminated, as indicated in block 314. In certain implementations, as shown in block 316, an indication may be output, for example, to one or more of the user (via an alternate communication channel), the client device 102, and/or the enterprise server 108.

In certain exemplary implementations, the process of determining if the detected DOM changes are consistent with the user's usual and/or historical behaviometric information can involve checking user profile data against recorded behavioral input. In some instance, DOM changes may stem from typical user settings, plugins, etc., that may be considered usual or normal during the user's browsing session, and which may be determined by checking the source of the current DOM changes against the user's profile for historical behaviometric input/entries/settings that caused a change in the DOM, but that are considered innocuous and normal for the specific user.

In some embodiments the current and/or historical behavioral inputs may be recorded inputs by the client device 102. In certain implementations, the user may be unaware that behavioral inputs are being recorded. In certain implementations, at least some of the behavioral inputs, can be recorded in the background without the knowledge of the user using the device. In some other embodiments the user may explicitly agree to the recording of his/her behavioral inputs.

In certain implementations, the behavioral inputs can include keystroke dynamics (how hard and spacing between key presses), mouse movement (position, how fast, acceleration, and/or timing compared to other inputs), swipe pressure, swipe position. In certain implementations, the behavioral inputs can include user settings, scripts, plugins, etc., that may, for example, intentionally alter the way a web page is displayed. In certain implementations, the behavioral inputs can be compared to the prior recorded behavioral inputs using one or more statistical tests to determine a threshold of closeness between past and present behavioral inputs. “Statistical tests” for purposes of this disclosure are defined as determining a distance of new behavioral samples of a variable (e.g., plugins, any/all keys or bigram flight times etc.) to the previously sampled distribution (the learned profile). In some implementations, this may be carried out by comparing the samples to a mean value of an assumed underlying distribution, which can be e.g. Gaussian or log-normal, or computing the Kullback-Leibler divergence which is a measure of the “surprise” or information gain of new samples to an underlying distribution, or if sufficient samples are available, perform a two-sample Kolmogorov-Smirnov or a Cucconi test to determine the similarity. In each of the above methods, a suitable accept/reject threshold may be set.

In accordance with certain exemplary implementations of the disclosed technology, authorizing continuation of the browsing session can be based on a predetermined similarity match of the one or more event-based mutations to entries in the user behaviometric history data. The threshold of closeness between past and present behavioral inputs may be used to determine a minimum required percentage match of the current and past behaviometric data to authorize continuation of the browsing session. The percentage match can be a match of how much of the input has been received, how much of the input matches that which is on record already, and/or closeness of the match based on a statistical determination. In certain implementations, previously stored behavioral data can be updated with data acquired while monitoring the client device 102.

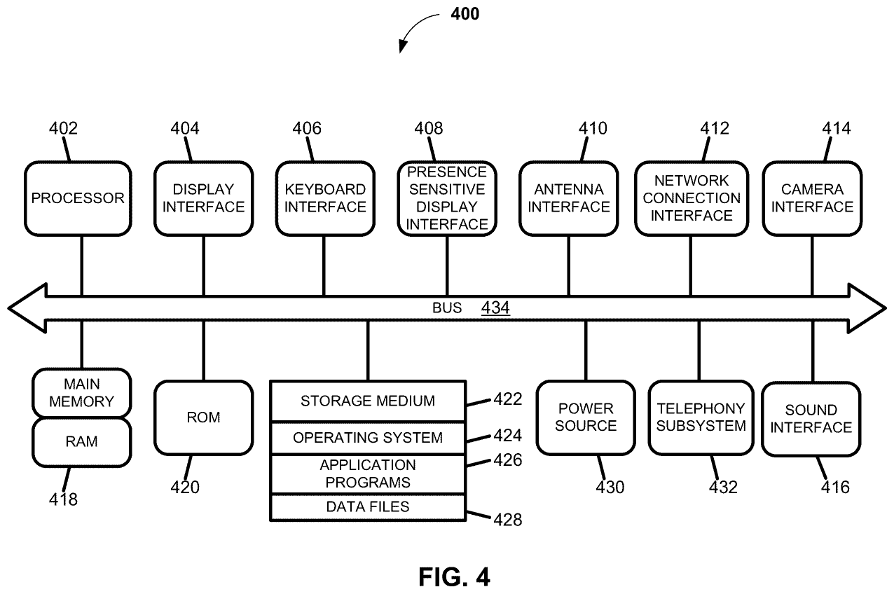

FIG. 4 depicts a block diagram of an illustrative computing device 400 that may be utilized to enable certain aspects of the disclosed technology. Various implementations and methods herein may be embodied in non-transitory computer-readable media for execution by a processor. It will be understood that the computing device 400 is provided for example purposes only and does not limit the scope of the various implementations of the communication systems and methods.

The computing device 400 of FIG. 4 includes one or more processors where computer instructions are processed. The computing device 400 may comprise the CPU 402, or it may be combined with one or more additional components shown in FIG. 4. In some instances, a computing device may be a processor, controller, or central processing unit (CPU). In yet other instances, a computing device may be a set of hardware components.

The computing device 400 may include a display interface 404 that acts as a communication interface and provides functions for rendering video, graphics, images, and texts on the display. In certain example implementations of the disclosed technology, the display interface 404 may be directly connected to a local display. In another example implementation, the display interface 404 may be configured for providing data, images, and other information for an external/remote display. In certain example implementations, the display interface 404 may wirelessly communicate, for example, via a Wi-Fi channel or other available network connection interface 412 to the external/remote display.

In an example implementation, the network connection interface 412 may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof. In one example, the display interface 404 may be operatively coupled to a local display. In another example, the display interface 404 may wirelessly communicate, for example, via the network connection interface 412 such as a Wi-Fi transceiver to the external/remote display.

The computing device 400 may include a keyboard interface 406 that provides a communication interface to a keyboard. According to certain example implementations of the disclosed technology, the presence-sensitive display interface 408 may provide a communication interface to various devices such as a pointing device, a touch screen, etc.

The computing device 400 may be configured to use an input device via one or more of the input/output interfaces (for example, the keyboard interface 406, the display interface 404, the presence-sensitive display interface 408, the network connection interface 412, camera interface 414, sound interface 416, etc.,) to allow a user to capture information into the computing device 400. The input device may include a mouse, a trackball, a directional pad, a trackpad, a touch-verified trackpad, a presence-sensitive trackpad, a presence-sensitive display, a scroll wheel, a digital camera, a digital video camera, a web camera, a microphone, a sensor, a smartcard, and the like. Additionally, the input device may be integrated with the computing device 400 or may be a separate device. For example, the input device may be an accelerometer, a magnetometer, a digital camera, a microphone, and an optical sensor.

Example implementations of the computing device 400 may include an antenna interface 410 that provides a communication interface to an antenna; a network connection interface 412 that provides a communication interface to a network. According to certain example implementations, the antenna interface 410 may utilize to communicate with a Bluetooth transceiver.

In certain implementations, a camera interface 414 may be provided that acts as a communication interface and provides functions for capturing digital images from a camera. In certain implementations, a sound interface 416 is provided as a communication interface for converting sound into electrical signals using a microphone and for converting electrical signals into sound using a speaker. According to example implementations, random-access memory (RAM) 418 is provided, where computer instructions and data may be stored in a volatile memory device for processing by the CPU 402.

According to an example implementation, the computing device 400 includes a read-only memory (ROM) 420 where invariant low-level system code or data for basic system functions such as basic input and output (I/O), startup, or reception of keystrokes from a keyboard are stored in a non-volatile memory device. According to an example implementation, the computing device 400 includes a storage medium 422 or other suitable types of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 424, application programs 426 (including, for example, a web browser application, a widget or gadget engine, and or other applications, as necessary) and data files 428 are stored. According to an example implementation, the computing device 400 includes a power source 430 that provides an appropriate alternating current (AC) or direct current (DC) to power components. According to an example implementation, the computing device 400 includes a telephony subsystem 432 that allows the computing device 400 to transmit and receive sound over a telephone network. The constituent devices and the CPU 402 communicate with each other over a computer bus 434.

In accordance with an example implementation, the CPU 402 has an appropriate structure to be a computer processor. In one arrangement, the computer CPU 402 may include more than one processing unit. The RAM 418 interfaces with the computer bus 434 to provide quick RAM storage to the CPU 402 during the execution of software programs such as the operating system application programs, and device drivers. More specifically, the CPU 402 loads computer-executable process steps from the storage medium 422 or other media into a field of the RAM 418 to execute software programs. Data may be stored in the RAM 418, where the data may be accessed by the computer CPU 402 during execution. In one example configuration, the computing device 400 includes at least 128 MB of RAM, and 256 MB of flash memory.

The storage medium 422 itself may include a number of physical drive units, such as a redundant array of independent disks (RAID), a floppy disk drive, a flash memory, a USB flash drive, an external hard disk drive, a thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer-readable storage media allow the computing device 400 to access computer-executable process steps, application programs, and the like, stored on removable and non-removable memory media, to off-load data from the computing device 400 or to upload data onto the computing device 400. A computer program product, such as one utilizing a communication system may be tangibly embodied in storage medium 422, which may comprise a machine-readable storage medium.

According to one example implementation, the term computing device, as used herein, may be a CPU, or conceptualized as a CPU (for example, the CPU 402 of FIG. 4). In this example implementation, the computing device (CPU) may be coupled, connected, and/or in communication with one or more peripheral devices.

It should also be understood by one skilled in the art that the devices depicted in FIG. 1 and/or FIG. 2 may be implemented on a computing device 400 such as is shown in FIG. 4.

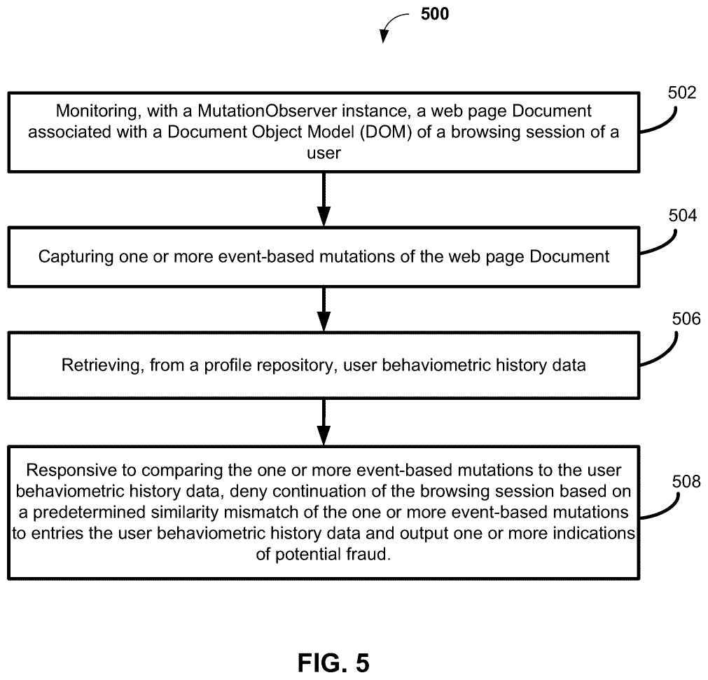

FIG. 5 is a flow diagram of a method 500 for client-side web page tampering assessment and fraud prevention by detection and of one or more events that are uncharacteristic of user-specific behavior. In block 502, the method 500 includes monitoring, with a MutationObserver instance, a web page Document associated with a Document Object Model (DOM) of a browsing session of a user. In block 504, the method 500 includes capturing one or more event-based mutations of the web page Document. In block 506, the method 500 includes retrieving, from a profile repository, user behaviometric history data. In block 508, the method 500 includes, responsive to comparing the one or more event-based mutations to the user behaviometric history data: authorizing continuation of the browsing session based on a predetermined similarity match of the one or more event-based mutations to entries in the user behaviometric history data; or denying continuation of the browsing session based on a predetermined similarity mismatch of the one or more event-based mutations to entries in the user behaviometric history data and output one or more indications of potential fraud.

In certain implementations, the one or more event-based mutations can include one or more of a visible mutation, a hidden mutation, a script injection, and/or a code-triggered field value change.

In certain implementations, the one or more event-based mutations of the web page Document may be associated with a JavaScript thread.

In accordance with certain exemplary implementations of the disclosed technology, the one or more event-based mutations of the web page Document may modify a value without changing visible content displayed to the user.

In certain implementations, responsive to the capturing the one or more event-based mutations, the MutationObserver instance may update a variable containing a list of document mutations triggered by a user interaction or code execution.

In certain implementations, pre-configuration or specific user journey events are not required for monitoring the DOM.

In certain implementations, the one or more event-based mutations may be related to user deception. In certain implementations, the one or more indications are output to mitigate fraud.

Certain implementations of the disclosed technology may further include updating and storing in the profile repository, user behaviometric history data based on captured event-based mutations of the web page Document that are usual user-specific document modifications. In certain implementations, the usual user-specific document modifications can include one or more of popup hiding, content translation, and/or forcing dark mode on a web page using one or more web browser extensions.

In accordance with certain exemplary implementations of the disclosed technology, capturing of the one or more event-based mutations of the web page Document can include recording visible and hidden mutations made to the web page Document with a timeline to detect user-specific behavior and identify fraudulent activities.

In certain implementations, the user behaviometric history data can include one or more of keystroke dynamics, key press time, key flight time, mouse movement, swipe pressure, swipe position, operating system, browser type, device information, screen refresh rate, and usual user-specific document modifications.

In accordance with certain exemplary implementations of the disclosed technology, if the browser is detected to be in private mode or is subject to an aggregator or malware, the types of actions taken in response to the detection can include marking the user session with an appropriate flag. In some instances, an alert to a fraud system or human operator may be generated. In accordance with certain exemplary implementations of the disclosed technology, a detection of privacy mode may not be enough to warrant an alert, however, the detection of malware may initiate the generation and sending of such an alert.

Implementations of the subject matter and the functional operations described herein may be implemented in various systems, digital electronic circuitry, computer software, firmware, or hardware, including the structures disclosed herein and their structural equivalents, or in combinations of one or more of them. Implementations of the subject matter described herein can be implemented as one or more computer program products, i.e., one or more modules of computer program instructions encoded on a tangible and non-transitory computer-readable medium for execution by, or to control the operation of, data processing apparatus. The computer-readable medium can be a machine-readable storage device, a machine-readable storage substrate, a memory device, a composition of matter affecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flow described in this specification can be performed by one or more programmable processors executing one or more computer programs to perform functions by operating on input data and generating output. The processes and logic flows can also be performed by, and apparatus can also be implemented as, special purpose logic circuitry, e.g., FPGA (field programmable gate array) or ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory, or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media, and memory devices, including by way of example semiconductor memory devices, e.g., EPROM, EEPROM, flash memory devices. The processor and the memory can be supplemented by, or incorporated into, special-purpose logic circuitry.

While this disclosure includes many specifics, these should not be construed as limitations on the scope of any of the disclosure or of what may be claimed, but rather as descriptions of features that may be specific to particular embodiments of particular inventions. Certain features that are described in the context of separate embodiments can also be implemented in combination in a single implementation. Conversely, various features that are described in the context of a single implementation can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described herein should not be understood as requiring such separation in all embodiments.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the disclosed technology.

We claim:

1. A method, comprising:
monitoring, with a MutationObserver instance, a web page Document associated with a Document Object Model (DOM) of a browsing session of a user;
capturing one or more event-based mutations of the web page Document;
retrieving, from a profile repository, user behaviometric history data; and
responsive to comparing the one or more event-based mutations to the user behaviometric history data, denying continuation of the browsing session based on a predetermined similarity mismatch of the one or more event-based mutations to entries in the user behaviometric history data and output one or more indications of potential fraud.

2. The method of claim 1, wherein the one or more event-based mutations comprise one or more of a visible mutation, a hidden mutation, a script injection, and/or a code-triggered field value change.

3. The method of claim 1, wherein the one or more event-based mutations of the web page Document are associated with a JavaScript thread.

4. The method of claim 1, wherein the one or more event-based mutations of the web page Document modifies a value without changing visible content displayed to the user.

5. The method of claim 1, wherein responsive to the capturing the one or more event-based mutations, the MutationObserver instance updates a variable containing a list of document mutations triggered by a user interaction or code execution.

6. The method of claim 1, wherein pre-configuration or specific user journey events are not required.

7. The method of claim 1, wherein the one or more event-based mutations are related to user deception, and wherein the one or more indications are output to mitigate fraud.

8. The method of claim 1, further comprising updating and storing in the profile repository, user behaviometric history data based on captured event-based mutations of the web page Document that are usual user-specific document modifications, and authorizing continuation of the browsing session based on a predetermined similarity match of the one or more event-based mutations to entries in the user behaviometric history data.

9. The method of claim 8, wherein the usual user-specific document modifications comprise one or more of popup hiding, content translation, and/or forcing dark mode on a web page using one or more web browser extensions.

10. The method of claim 1, wherein the capturing of the one or more event-based mutations of the web page Document comprises recording visible and hidden mutations made to the web page Document with a timeline to detect user-specific behavior and identify fraudulent activities.

11. The method of claim 1, wherein the user behaviometric history data comprises one or more of keystroke dynamics, key press time, key flight time, mouse movement, swipe pressure, swipe position, operating system, browser type, device information, screen refresh rate, and usual user-specific document modifications.

12. A system, comprising:
a processor; and
a memory having programming instructions stored thereon, which, when executed by the processor, cause the processor to:
monitor, with a MutationObserver instance, a web page Document associated with a Document Object Model (DOM) of a browsing session of a user;
detect one or more event-based mutations of the web page Document;
store the one or more event-based mutations in the memory;
retrieve, from a profile repository, user behaviometric history data;
compare the one or more event-based mutations to the user behaviometric history data; and
deny continuation of the browsing session based on a predetermined similarity mismatch of the one or more event-based mutations to entries in the user behaviometric history data and output one or more indications of potential fraud.

13. The system of claim 12, wherein the one or more event-based mutations comprise one or more of a visible mutation, a hidden mutation, a script injection, and/or a code-triggered field value change.

14. The system of claim 12, wherein the one or more event-based mutations of the web page Document are associated with a JavaScript thread.

15. The system of claim 12, wherein the one or more event-based mutations of the web page Document modifies a value without changing visible content displayed to the user.

16. The system of claim 12, wherein responsive to capturing the one or more event-based mutations, the MutationObserver instance updates a variable containing a list of document mutations triggered by a user interaction or code execution.

17. The system of claim 12, wherein the programming instructions further cause the processor to update and store in the profile repository, user behaviometric history data based on captured event-based mutations of the web page Document that are usual user-specific document modifications and authorize continuation of the browsing session based on a predetermined similarity match of the one or more event-based mutations to entries in the user behaviometric history data.

18. The system of claim 17, wherein the usual user-specific document modifications comprise one or more of popup hiding, content translation, and/or forcing dark mode on a web page using one or more web browser extensions.

19. The system of claim 12, wherein the user behaviometric history data comprises one or more of keystroke dynamics, key press time, key flight time, mouse movement, swipe pressure, swipe position, operating system, browser type, device information, screen refresh rate, and usual user-specific document modifications.

20. A non-transitory computer-readable medium having stored thereon software instructions that, when executed by a processor, cause the processor to perform a method of:
monitoring, with a MutationObserver instance, a web page Document associated with a Document Object Model (DOM) of a browsing session of a user;
capturing one or more event-based mutations of the web page Document;
retrieving, from a profile repository, user behaviometric history data;
responsive to comparing the one or more event-based mutations to the user behaviometric history data, denying continuation of the browsing session based on a predetermined similarity mismatch of the one or more event-based mutations to entries in the user behaviometric history data and output one or more indications of potential fraud.
